(19) United States
(12) Patent Application Publication
(10) Pub. No.: US 2008/0278435 A1
(43) Pub. Date: Nov. 13, 2008

(54) DISPLAY DEVICE AND METHOD OF MANUFACTURING THE SAME

(75) Inventors: Keun-Kyu SONG, Yongin-si (KR); Seong-Sik SHIN, Seongnam-si (KR)

Correspondence Address: H.C. PARK & ASSOCIATES, PLC, 8500 LEESBURG PIKE, SUITE 7500, VIENNA, VA, 22182, US

(73) Assignee: SAMSUNG ELECTRONICS CO., LTD., Suwon-si (KR)

(21) Appl. No.: 12/110,655

(22) Filed: Apr. 28, 2008

(30) Foreign Application Priority Data
May 9, 2007 (KR) 10-2007-0045208

(51) Int. Cl. G09G 3/34

(52) U.S. Cl. 345/107

(57) ABSTRACT

Disclosed herein are a display device to prevent light from being incident to a thin film transistor, and a method of manufacturing the same. An electrophoretic device includes a first substrate including a display area and a non-display area, a first thin film transistor connected to a gate line and a data line disposed in the display area, a driving circuit including a second thin film transistor disposed in the non-display area, a plurality of microcapsules disposed on the first substrate and including charged pigment particles, and a first light shielding layer overlapping a channel region of the second thin film transistor and disposed between the second thin film transistor and the microcapsules.

### CROSS-REFERENCE TO RELATED APPLICATION

This application claims priority from and the benefit of Korean Patent Application No. 10-2007-0045208, filed on May. 9, 2007, which is hereby incorporated by reference for all purposes as if fully set forth herein.

### BACKGROUND OF THE INVENTION

1. Field of the Invention

The present invention relates to a display device and, more particularly, to a display device that may prevent light from being incident to a thin film transistor, and a method of manufacturing the same.

2. Discussion of the Background

The importance of information display devices has increased in recent years. An electrophoretic device is a flat panel display device that may be used in electronic books, electronic newspapers, and the like. The electrophoretic device includes two substrates, on which electrodes to generate an electric field are disposed, and microcapsules disposed between the substrates. For example, the microcapsules may include white and black pigment particles that are positively charged and negatively charged, respectively.

Since such an electrophoretic device may have high reflectivity and a high contrast ratio and may be less dependent on viewing angle than a liquid crystal display, it may be possible to display an image as if on paper. Moreover, since it has bistable characteristics of black and white, it may be possible to maintain a stable image without continuously applying a voltage thereto, which may result in low power consumption. Here, in the electrophoretic device, when an electric potential difference is produced between two electrodes, the charged black and white pigment particles move to opposite sides, and thus colors of the charged pigment particles that move toward the front substrate can be seen from a viewing side.

Meanwhile, the electrophoretic device includes a thin film transistor serving as a switching element to control the charged pigment particles. In this case, when light supplied from the outside is incident to a channel region of the thin film transistor, current leakage may occur. Accordingly, the thin film transistor may be unable to control the charged pigment particles, thus deteriorating the display quality.

### SUMMARY OF THE INVENTION

The present invention provides a display device including a light shielding layer that may prevent a light leakage current of a thin film transistor, and a method of manufacturing the same.

Additional features of the invention will be set forth in the description which follows, and in part will be apparent from the description, or may be learned by practice of the invention.

The present invention discloses an electrophoretic device including a first substrate including a display area and a non-display area a first thin film transistor connected to a gate line and a data line and disposed in the display area, a driving circuit including a second thin film transistor disposed in the non-display area a plurality of microcapsules disposed on the first substrate and including charged pigment particles, and a first light shielding layer overlapping a channel region of the second thin film transistor and disposed between the second thin film transistor and the microcapsules.

The present invention also discloses a method of manufacturing an electrophoretic device including forming a first thin film transistor in a display area of a first substrate and a second thin film transistor constituting a driving circuit in a non-display area of the first substrate, forming a light shielding layer overlapping channel regions of the first and second thin film transistors, disposing microcapsules on the light shielding layer, and bonding a second substrate to the first substrate with the microcapsules disposed therebetween.

The present invention also discloses a display device equipped with a driving circuit. The display device includes a substrate including a display area and a non-display area, a first thin film transistor connected to a gate line and a data line and disposed in the display area, a driving circuit including a second thin film transistor disposed in the non-display area, and first and second light shielding layers overlapping channel regions of the first and second thin film transistors, respectively.

The present invention also discloses a method of manufacturing a display device equipped with a driving circuit. The method includes forming a first thin film transistor in a display area of a substrate and a second thin film transistor constituting a driving circuit in a non-display area of the substrate, and forming first and second light shielding layers overlapping channel regions of the first and second thin film transistors, respectively.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is plan view of an electrophoretic device in accordance with an exemplary embodiment of the present invention.

FIG. 2 is a partial cross-sectional view of a display area of the electrophoretic device shown in FIG. 1.

FIG. 3 is a partial cross-sectional view of a non-display area of the electrophoretic device shown in FIG. 1.

FIG. 4 is an exemplary diagram of a gate driving circuit shown in FIG. 1.

FIG. 5 is a partial cross-sectional view of an electrophoretic device in accordance with another exemplary embodiment of the present invention.

FIG. 6 is a flowchart showing a method of manufacturing the electrophoretic device in accordance with the exemplary embodiment of the present invention. and

FIG. 7A, FIG. 7B, FIG. 7C, FIG. 7D, and FIG. 7E are cross-sectional views showing the method of manufacturing the electrophoretic device according to the flowchart of FIG. 6.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

It will be understood that when an element or layer is referred to as being “on” or “connected to” another element or layer, it can be directly on or directly connected to the other element or layer, or intervening elements or layers may be present. In contrast, when an element is referred to as being “directly on” or “directly connected to” another element or layer, there are no intervening elements or layers present.

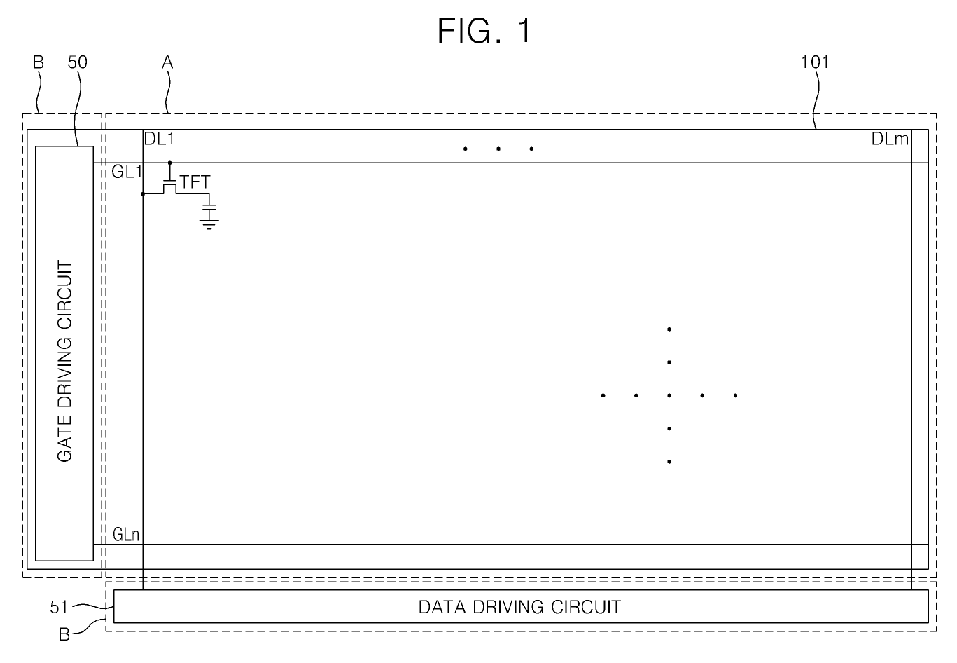

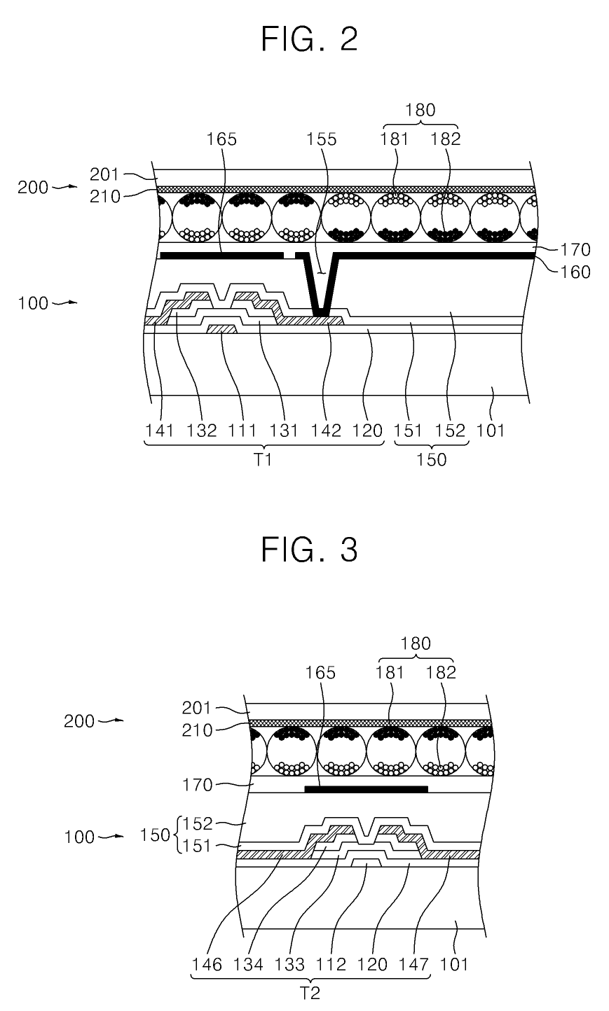

First, an electrophoretic device in accordance with an exemplary embodiment of the present invention will be described with reference to FIG. 1 and FIG. 2.

FIG. 1 is plan view of an electrophoretic device in accordance with an exemplary embodiment of the present invention, FIG. 2 is a partial cross-sectional view of a display area of the electrophoretic device shown in FIG. 1, and FIG. 3 is a partial cross-sectional view of a non-display area of the electrophoretic device shown in FIG. 1.

As shown in FIG. 1, the electrophoretic device in accordance with the exemplary embodiment of the present invention is a display device equipped with a gate driving circuit 50 and is divided into a display area A and a non-display area B, the configurations of which will be described with reference to FIG. 2 and FIG. 3.

Referring to FIG. 1, FIG. 2, and FIG. 3, the electrophoretic device includes first and second substrates 100 and 200 bonded together over the display area A and the non-display area B with microcapsules 180 disposed therebetween.

The microcapsules 180 may be made of a transparent thin film and may include charged white and black pigment particles 181 and 182 that are positively charged and negatively charged, respectively. When a voltage is applied to two electrodes facing each other, an electric field is generated due to the electric potential differences between the electrodes. When this electric field is applied to the microcapsules 180, the white and black particles 181 and 182 in each microcapsule 180 move toward electrodes having opposite polarities. Accordingly, the charged pigment particles 181 and 182 of the microcapsules 180 may reflect light incident from the outside and thus an image composed of black or white may be displayed.

The first substrate 100 may be positioned at the bottom of the microcapsules 180 and bonded to the second substrate 200 using sealant, not depicted, with the microcapsules 180 and a polymer solvent (not shown) disposed therebetween.

As shown in FIG. 1 and FIG. 2, the display area A of the first substrate 100 includes gate lines GL1-GLn, data lines DL1-DLm, a first thin film transistor (TFT) T1, a passivation layer 150, a first electrode 160, a light shielding layer 165, and a bonding layer 170. As shown in FIG. 1 and FIG. 3, the non-display area B of the first substrate 100 includes a second TFT T2 constituting the gate driving circuit 50, a passivation layer 150, a light shielding layer 165, and a bonding layer 170. Here, a description of the same elements will be omitted.

The gate line GL1 extends in the horizontal direction and may be a single layer structure or a multilayer structure and may include chromium (Cr), aluminum (Al), molybdenum (Mo), silver (Ag), and/or titanium (Ti). The data line DL1 extends in the vertical direction and may be a single layer structure or a multilayer structure and may include Cr, Al, Mo, Ag, and/or Ti.

The first TFT T1 is disposed where the gate line GL1 crosses the data line DL1. The first TFT T1 includes a first gate electrode 111, a gate insulating layer 120, a first active layer 131, a first ohmic contact layer 132, a first source electrode 141, and a first drain electrode 142.

The first gate electrode 111 is connected to the gate line GL1. The first gate electrode 111 turns the first TFT T1 on or off using a gate on/off voltage applied from the gate line GL1. The gate insulating layer 120 is disposed on the gate line GL1 and the first gate electrode 111 to insulate the gate line GL1 and the first gate electrode 111. To this end, the gate insulating layer 120 may include silicon nitride (SiNₓ) or silicon oxide (SiOₓ). The first active layer 131 may include amorphous silicon and a portion thereof may be etched to form a channel of the first TFT T1. The first ohmic contact layer 132 provides an ohmic contact between the first source electrode 141, the first drain electrode 142, and the first active layer 131.

The first source electrode 141 protrudes from a side of the data line DL1. When the first TFT T1 is turned on, the first source electrode 141 supplies a data voltage from the data line DL1 to the first drain electrode 142 by way of the channel of the first TFT T1. The first drain electrode 142 may include the same material as the data line DL1 and may face the first source electrode 141. The first drain electrode 142 supplies the data voltage transmitted from the first source electrode 141 to the first electrode 160, which will be described below. As above, although the first TFT T1 of this exemplary embodiment is a bottom gate type transistor with an etch back type channel structure, the TFT T1 may alternatively be a top gate type transistor.

The second TFT T2 may include similar elements as the first TFT T1. Accordingly, a description of the same elements will be omitted. The channel regions of the first and second TFTs T1 and T2 and the gate driving circuit 50 will be described below.

The passivation layer 150 in accordance with the exemplary embodiment of the present invention may include a first passivation layer 151 and a second passivation layer 152.

The first passivation layer 151 may be disposed on the entire surface of the display area A and the non-display area B. Moreover, the first passivation layer 151 is disposed on the first and second TFTs T1 and T2 to insulate metal layers of the first and second TFTs T1 and T2 from other metal layers. Here, the first passivation layer 151 may include an inorganic material to reduce an off-current due to interfacial characteristics between the first and second active layers 131 and 133 and an organic material. For example, the first passivation layer 151 may include SiNₓ or SiOₓ.

The second passivation layer 152 may be disposed on the entire surface of the display area A and the non-display area B as with the first passivation layer 151. Moreover, the second passivation layer 152 may be disposed on the first passivation layer 151 to provide a flat surface for the thin film formation of the first electrode 160 connected to the first TFT T1. Here, the second passivation layer 152 may include an organic material such as acryl, polyimide, and benzocyclobutene (BCB).

Meanwhile, the passivation layer 150 is not required to include both the first and second passivation layers 151 and 152, and alternatively may include the second passivation layer 152 only.

The first electrode 160 is disposed on the passivation layer 150 in a pattern. The first electrode 160 is connected to the first drain electrode 142 through a contact hole 155. The first electrode 160 forms an electric field together with a second electrode, which will be described below, using the data voltage supplied from the first drain electrode 142, thereby driving the charged pigment particles 181 and 182 of the microcapsules 180. The first electrode 160 may include a transparent metal such as indium tin oxide (ITO) and/or indium zinc oxide (IZO), or an opaque metal. Here, the first electrode 160 may include a reflective material to reflect light incident.

The light shielding layer 165 is disposed on the passivation layer 150. Moreover, the light shielding layer 165 may overlap the channel regions of the first and second TFTs T1 and T2 disposed on the display area A and the non-display area B, respectively. The light shielding layer 165 and the gate driving circuit 50 will be described in more detail below.

As shown in FIG. 1, the gate driving circuit 50 is disposed in the non-display area B of the first substrate 100. In this case, the gate driving circuit 50 includes a plurality of second TFTs T2 having an amorphous silicon gate (ASG). For example, the gate driving circuit 50 may include seven or fifteen second TFTs T2 connected to one another. In this case, the gate driving circuit 50 generates the gate on/off signal to drive the gate lines GL1-GLn of the display area A. In more detail, the gate driving circuit 50 generates the gate on/off signal to turn the first TFT T1 of the display area A on or off using a driving voltage and a control signal. Moreover, the gate driving circuit 50 supplies the gate on/off signal to the gate line GL1.

The second TFT T2 constituting the gate driving circuit 50 may be a bottom gate type transistor with an etch back type channel structure or a top gate type transistor as with the first TFT T1. When light is incident to the channel region of the second TFT T2, a light leakage current is generated, which deteriorates the characteristics of the TFT T2. According to this, the gate driving circuit 50 may have a problem driving the first TFT T1. In order to prevent the deterioration of the TFT characteristics, the light shielding layer 165 is disposed on the first and second TFTs T1 and T2. Here, the light shielding layer 165 may include an opaque metal to shield light. For example, the light shielding layer 165 may include a reflective metal such as Ag, Cr, and/or Mo. Accordingly, the light shielding layer 165 may prevent the light from being incident to the channel regions of the first and second TFTs T1 and T2 and may increase light reflection efficiency.

The second substrate 200 includes a protective substrate 201 and a second electrode 210.

The protective substrate 201 may include a transparent material to protect the microcapsules 180 from external impact and to enable a user to view an image displayed by the charged pigment particles 181 and 182. For example, the protective substrate 201 may include a plastic or glass film.

The second electrode 210 is disposed on the microcapsules 180 to face the first electrode 160. Moreover, the second electrode 210 may include a transparent material so that the incident light can be transmitted therethrough the same as with the protective substrate 201. For example, the second electrode 210 may include ITO or IZO.

The second electrode 210 applies an electric field to the charged pigment particles 181 and 182 of the microcapsules 180. The second electrode 210 forms an electric field together with the first electrode 160 to control the white and black particles 181 and 182.

In the present embodiment, a data driving circuit 51 may be further included in the non-display area B, which generates a data controlling signal, and transmits the generated data controlling signal to the data lines DL1 to DLm.

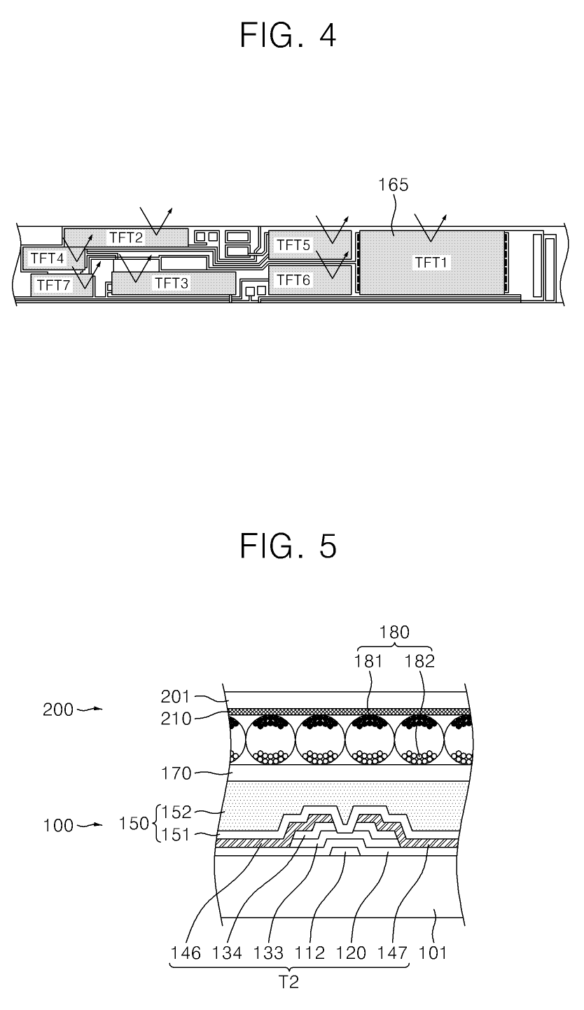

Next, the gate driving circuit shown in FIG. 1 in accordance with the exemplary embodiment of the present invention will be described with reference to FIG. 4.

FIG. 4 is an exemplary diagram of the gate driving circuit shown in FIG. 1.

As shown in FIG. 4, the gate driving circuit includes first, second, third, fourth, fifth, sixth, and seventh TFTs TFT1, TFT2, TFT3, TFT4, TFT5, TFT6, and TFT7 connected to each other to transmit and receive signals. Here, the light shielding layer 165 is disposed on the first, second, third, fourth, fifth, sixth, and seventh TFTs TFT1, TFT2, TFT3, TFT4, TFT5, TFT6, and to TFT7. The light shielding layer 165 overlaps the first, second, third, fourth, fifth, sixth, and seventh TFTs TFT1, TFT2, TFT3, TFT4, TFT5, TFT6, and TFT7 to prevent the light from being incident to the channel regions.

In the following, an electrophoretic device in accordance with another exemplary embodiment of the present invention will be described with reference to FIG. 5.

FIG. 5 is a partial cross-sectional view of an electrophoretic device in accordance with another exemplary embodiment of the present invention.

The electrophoretic device in accordance with another exemplary embodiment of the present invention includes an opaque passivation layer 150, differently from that shown in FIG. 1, FIG. 2, and FIG. 3. A detailed description of the same elements except for the passivation layer 150 will be omitted.

In particular, the passivation layer 150 includes a first passivation layer 151 disposed on the first and second TFTs T1 and T2, a second passivation layer 152 disposed on the first passivation layer 151. The second passivation layer 152 may include an organic material to prevent light transmission. For example, the second passivation layer 152 may include a resin having an optical density that is the same as that of a black matrix used in a liquid crystal display device. Moreover, the second passivation layer 152 may include a resin having an optical density of more than 3.0. When the second passivation layer 152 includes a resin having an optical density of less than 3.0, it may be difficult to effectively prevent light from being incident to channel regions of the first and second TFTs T1 and T2. Especially, the second passivation layer 152 may include a resin having an optical density of more than 3.6.

Such a passivation layer 150 is disposed on the entire surface of the display area A and the non-display area B. Accordingly, the passivation layer 150 prevents light transmitted through the microcapsules 180 from being incident to the channel regions of the first and second TFTs T1 and T2.

The light shielding layer 165 and the opaque passivation layer 150 in accordance with exemplary embodiments of the present invention are not limited to the electrophoretic device, but may be applied to any display device equipped with a driving circuit.

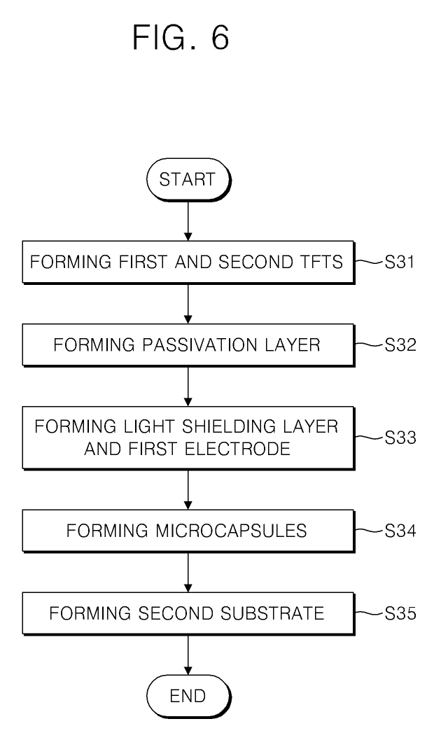

Next, a method of manufacturing the electrophoretic device in accordance with the exemplary embodiment of the present invention will be described with reference to FIG. 6.

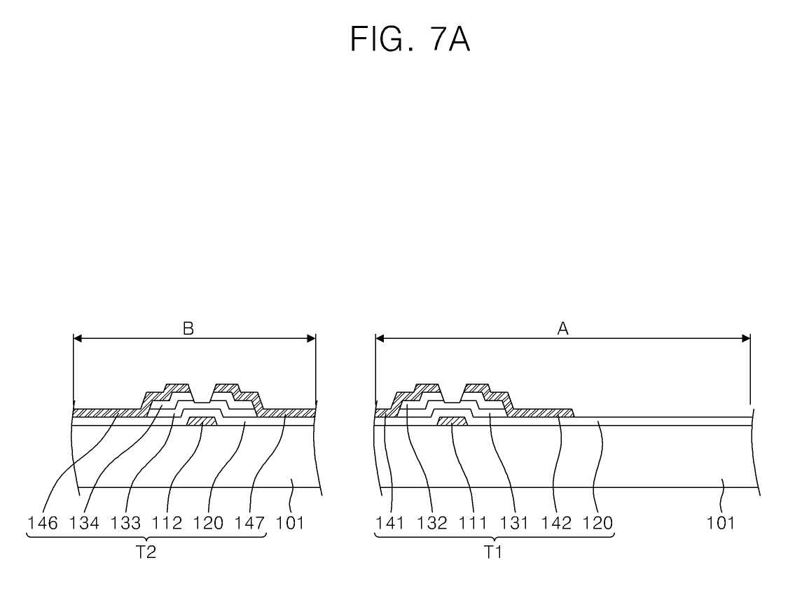

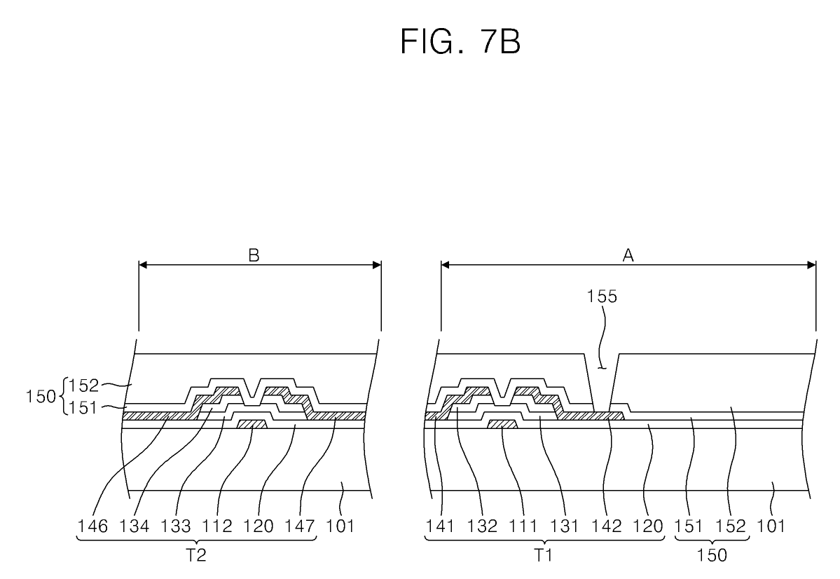

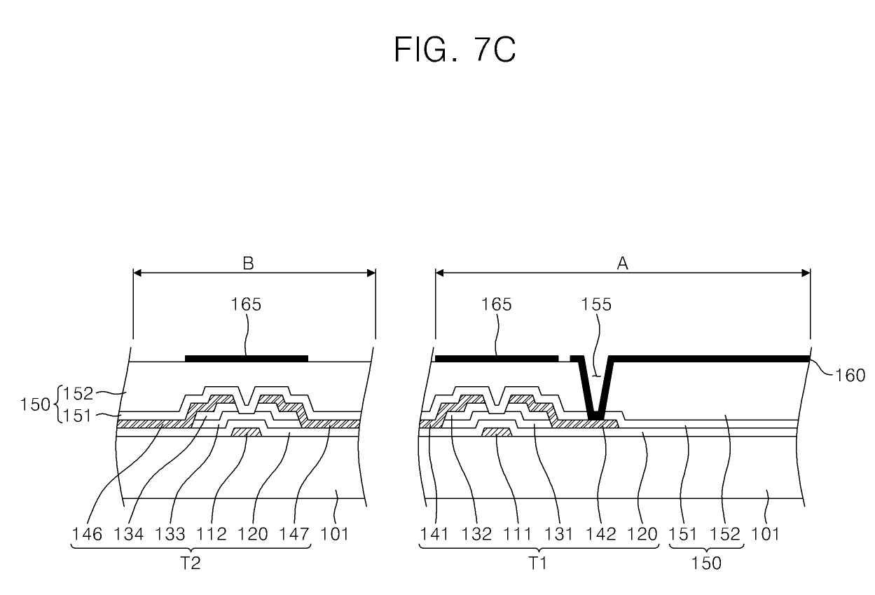

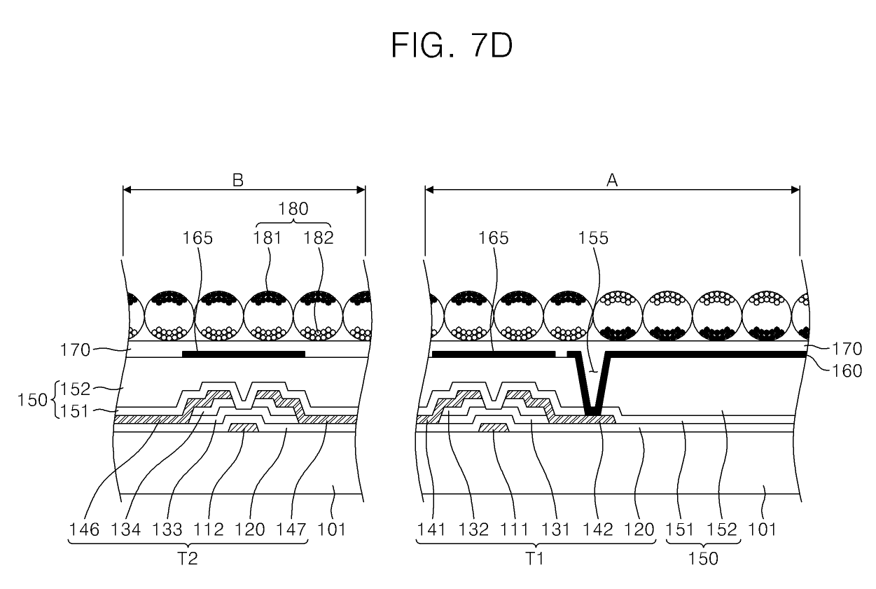

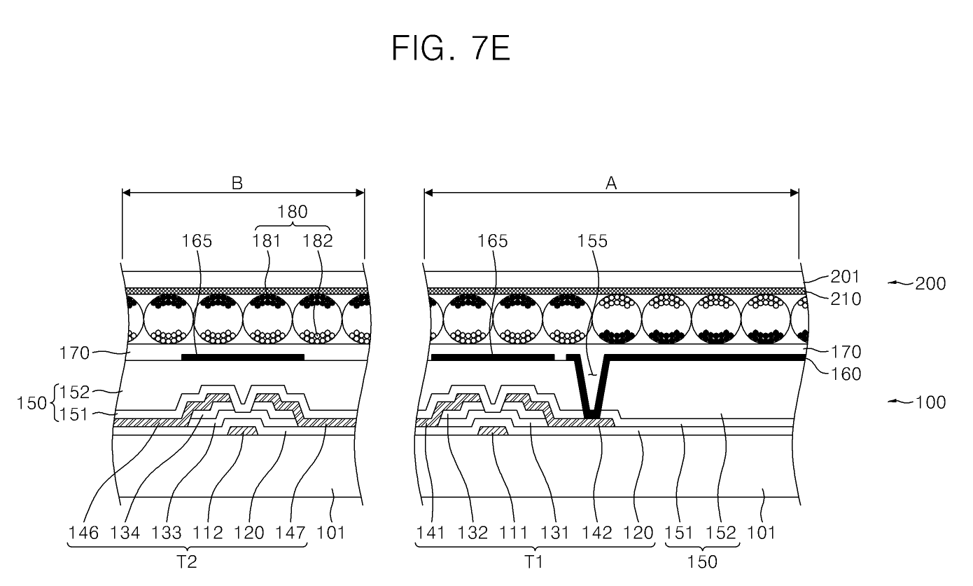

FIG. 6 is a flowchart showing a method of manufacturing the electrophoretic device in accordance with the exemplary embodiment of the present invention, and FIG. 7A, FIG. 7B, FIG. 7C, FIG. 7D, and FIG. 7E are cross-sectional views showing the method of manufacturing the electrophoretic device according to the flowchart of FIG. 6.

As shown in FIG. 6, a method of manufacturing an electrophoretic device includes forming first and second TFTs T1 and T2 (step S31), forming a passivation layer 150 (step S32), forming a light shielding layer 165 and a first electrode 160 (step S33), forming microcapsules 180 (step S34), and forming a second substrate 200 (step S35).

First, referring to FIG. 7A, first and second TFTs T1 and T2 are formed on a lower substrate 101 of a first substrate 100 divided into a display area A and a non-display area B (S31).

More specifically, the first TFT T1 is formed such that a first gate electrode 111, a gate insulating layer 120, a first active layer 131, a first ohmic contact layer 132, a first source electrode 141, and a first drain electrode 142 are stacked and patterned. Here, the first TFT T1 is a bottom gate type transistor with an etch back type channel structure. The second TFT T2 is formed such that a second gate electrode 112, a gate insulating layer 120, a second active layer 133, a second ohmic contact layer 134, a second source electrode 146, and a second drain electrode 147 are stacked and patterned. Here, the second TFT T2 is a bottom gate type transistor with an etch back type channel structure like the first TFT T1.

Referring to FIG. 7B, a passivation layer 150 is formed on the first and second TFTs T1 and T2 (step S32). In this case, the passivation layer 150 includes a first passivation layer 151 and a second passivation layer 152.

First, the first passivation layer 151 may include an inorganic material on the first and second TFTs T1 and T2. Here, the first passivation layer 151 may include SiNₓ or SiOₓ. The second passivation layer 152 is formed on the first passivation layer 151 to have a flat surface. Here, the second passivation layer 152 may include an organic material, such as acryl, polyimide, and benzocyclobutene (BCB). Moreover, the second passivation layer 152 in accordance with another exemplary embodiment of the present invention may include propyleneglycol monomethyletheracetate, carbon black, or cyclohexanone. Furthermore, a contact hole 155 is formed in a portion of the first and second passivation layers 151 and 152 to expose a portion of the first drain electrode 142.

Referring to FIG. 7C, a light shielding layer 165 and a first electrode 160 are formed on the passivation layer 150 (step S33).

The light shielding layer 165 is formed to overlap the channel regions of the first and second TFTs T1 and T2. In this case, the light shielding layer 165 may include an opaque metal. For example, the light shielding layer 165 may include a reflective metal, such as Ag, Cr, or Mo.

The first electrode 160 is formed on the passivation layer 150 on the same plane as the light shielding layer 165. Here, the first electrode 160 is connected to the first drain electrode 142 through the contact hole 155. Moreover, the first electrode 160 may include an opaque metal, which may be the same material included in the light shielding layer 165. Furthermore, the first electrode 160 may include a transparent metal that is different from the material included in the light shielding layer 165.

Referring to FIG. 7D, microcapsules 180 are disposed on the first substrate 100 (step S34).

Here, a process of forming a bonding layer 170 on the passivation layer 150, the light shielding layer 165, and the first electrode 160 is further provided before the microcapsules 180 are formed. The bonding layer 170 is formed on the entire surface of the first substrate 100. Then, the microcapsules 180 are disposed on the bonding layer 170.

Last, referring to FIG. 7E, a second substrate 200 is formed to include a second electrode 210 on a protective substrate 201 (step S35).

In detail, the second electrode 210 is formed on the protective substrate 201 formed of plastic or glass. The second electrode 210 may include a transparent conductive material, such as ITO or IZO. Moreover, the second substrate 200 may be bonded to the first substrate 100 using sealant, not depicted, with the microcapsules 180 disposed therebetween, in which a polymer solvent, not depicted, is filled.

The method of forming the light shielding layer 165 and the passivation layer 150 in accordance with the present embodiment of the present invention is not limited to a method of manufacturing an electrophoretic device, but may be applied to any method of manufacturing a display device equipped with a driving circuit.

As described above, the electrophoretic device in accordance with exemplary embodiments of the present invention includes the light shielding layer formed of a metal on the thin film transistor to prevent light from being incident to the channel area of the thin film transistor. Moreover, the electrophoretic device includes the passivation layer including a resin capable of shielding light. Accordingly, the electrophoretic device in accordance with exemplary embodiments of the present invention can prevent the deterioration of the TFT characteristics due to the light leakage current, thus improving the display quality. Furthermore, the light shielding layer and the passivation layer in accordance with the exemplary embodiments of the present invention can be applied to any display device equipped with a driving circuit, in addition to an electrophoretic device, which may prevent the deterioration of the TFT characteristics and improve the display quality.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. An electrophoretic device, comprising:
a first substrate comprises a display area and a non-display area;
a first thin film transistor connected to a gate line and a data line and disposed in the display area;
a driving circuit comprising a second thin film transistor disposed in the non-display area;
a plurality of microcapsules disposed on the first substrate and comprising charged pigment particles; and
a first light shielding layer overlapping a channel region of the second thin film transistor and disposed between the second thin film transistor and the microcapsules.

2. The electrophoretic device of claim 1, further comprising a second light shielding layer overlapping a channel region of the first thin film transistor and disposed between the first thin film transistor and the microcapsules.

3. The electrophoretic device of claim 2, further comprising a passivation layer disposed on the first thin film transistor and the second thin film transistor, the first light shielding layer and the second light shielding layer being disposed on the passivation layer.

4. The electrophoretic device of claim 3, further comprising a first electrode disposed on the passivation layer and connected to the first thin film transistor.

5. The electrophoretic device of claim 4, further comprising a second substrate, on which a second electrode is disposed to face the first electrode, the second substrate being bonded to the first substrate.

6. The electrophoretic device of claim 4, wherein the first light shielding layer and the second light shielding layer each comprise an opaque metal.

7. The electrophoretic device of claim 6, wherein the first electrode comprises the same material as the first light shielding layer and the second light shielding layer.

8. The electrophoretic device of claim 6, wherein the first electrode comprises a material different from that of the first light shielding layer and the second light shielding layer.

9. The electrophoretic device of claim 2, wherein the first light shielding layer and the second light shielding layer are a passivation layer that planarizes top surfaces of the first thin film transistor and the second thin film transistor.

10. The electrophoretic device of claim 9, wherein the passivation layer comprises a resin having an optical density to prevent light from being incident to the thin film transistors.

11. The electrophoretic device of claim 1, wherein the driving circuit comprises a gate driving circuit.

12. A method of manufacturing an electrophoretic device, the method comprising:
forming a first thin film transistor in a display area of a first substrate and forming a second thin film transistor constituting a driving circuit in a non-display area of the first substrate;
forming a light shielding layer overlapping channel regions of the first thin film transistor and the second thin film transistor;
disposing microcapsules on the light shielding layer; and
bonding a second substrate to the first substrate with the microcapsules disposed therebetween.

13. The method of claim 12, further comprising forming a passivation layer on the first thin film transistor and the second thin film transistor.

14. The method of claim 13, further comprising forming a first electrode connected to the first thin film transistor.

15. The method of claim 14, wherein the light shielding layer and the first electrode each comprise an opaque metal.

16. The method of claim 15, wherein the light shielding layer and the first electrode are formed simultaneously.

17. The method of claim 12, wherein the light shielding layer is a passivation layer that planarizes the first thin film transistor and the second thin film transistor.

18. The method of claim 17, wherein the passivation layer comprises a resin having an optical density to prevent light from being incident to the thin film transistors.

19. A display device equipped with a driving circuit, the display device comprising:
a substrate comprising a display area and a non-display area;
a first thin film transistor connected to a gate line and a data line and disposed in the display area;
a driving circuit comprising a second thin film transistor disposed in the non-display area; and
a first light shielding layer and a second light shielding layer overlapping channel regions of the first thin film transistor and the second thin film transistor, respectively.

20. The display device of claim 19, wherein the first light shielding layer and the second light shielding layer both comprise either an opaque metal or a light shielding resin.

21. The method of claim 19, wherein the driving circuit comprises a gate driving circuit.

22. A method of manufacturing a display device equipped with a driving circuit, the method comprising:
forming a first thin film transistor in a display area of a substrate and forming a second thin film transistor constituting a driving circuit in a non-display area of the substrate; and
forming a first light shielding layer and a second light shielding layer overlapping channel regions of the first thin film transistor and the second thin film transistor, respectively.

23. The method of claim 22, wherein the first light shielding layer and the second light shielding layer both comprise either an opaque metal or a light shielding resin.

24. A display device, comprising:
a first substrate comprises a display area and a non-display area;
a first thin film transistor connected to a gate line and a data line and disposed in the display area;
a gate driving circuit comprising a second thin film transistor disposed in the non-display area;
and
a first light shielding layer overlapping a channel region of the second thin film transistor;
wherein the first light shielding layer comprises an opaque metal.
